(19) United States
(12) Patent Application Publication
(10) Pub. No.: US 2005/0158416 A1
(43) Pub. Date: Jul. 21, 2005

(54) Device for extruding flowable substances

(75) Inventors: Matthias Kleinhans, Waiblingen (DE); Stephan Gierke, Bremen (DE); Konrad Schermutzki, Remseck (DE)

Correspondence Address: BURNS DOANE SWECKER & MATHIS L L P, POST OFFICE BOX 1404, ALEXANDRIA, VA, 22313-1404, US

(73) Assignee: Santrade Ltd., Luzen (CH)

(21) Appl. No.: 10/484,934

(22) PCT Filed: Jul. 4, 2002
(86) PCT No.: PCT/EP02/07395

(30) Foreign Application Priority Data
Jul. 27, 2001 (DE) 101 38 333.9

(51) Int. Cl. B29C 67/02

(52) U.S. Cl. 425/6

(57) ABSTRACT

An extruder for extruding a flowable substance in the form of droplets includes a perforated rotating drum, and a nozzle strip arranged inside the drum at a lower portion thereof in facing relationship to an inner circumference of the drum. A cantilevered restricting strip is disposed within a flow channel of the nozzle strip to form a flow-restricting slot for apportioning and calming the flowing substance.

### BACKGROUND OF THE INVENTION

The invention relates to a device for extruding flowable substances comprising a rotating cylindrical drum provided with apertures over the entire circumference, a feed device for the substance fixedly arranged inside the drum, and a nozzle strip with a flow channel connected to said feed device and arranged at the lower region of the inner circumference of the drum through which the substances are fed uniformly across the axial length of the drum to the apertures where the substances are forced out from said apertures in the shape of droplets, which fall on a conveyor and/or cooling belt moving under the drum and solidify thereon.

A device of this type is disclosed in EP 0 145 839 A2 wherein the perforated drum moves around the circumference of an inner cylinder, which is provided with a feed channel that is axially fed from the front, a separating chamber extending parallel to said feed channel, and a nozzle strip inserted into a groove at the outer circumference of said cylinder. Said nozzle strip is provided with a plurality of borings arranged axially at a distance to one another whereby said borings are connected to a continuous groove forming an exit chamber in the nozzle strip which abuts the inner circumference of the rotating perforated drum.

Devices of this type have shown to be extremely advantageous for granulating certain substances. However, the production capacity of such devices is limited since the speed of such rotating drums cannot be increased at will because of the developing centrifugal forces whereby the drums have normally a diameter in the range of 80 mm.

It has also been shown that the interior, especially the area of the nozzle strip, has a tendency to clog in the region of its through-boring, particularly during granulating of products depositing sediments, such as suspensions, and that residues are formed therefore which can negatively influence the production process and whereby said residues would have to be removed at regular intervals. Arbitrary enlargement of the apertures would in turn lead to uncontrolled extrusion of the substances with the result that the desired droplet shaping cannot be achieved at the point of exit above the cooling belt.

The present invention is therefore based on the object to search for a solution through which the flow rate of the substance to be extruded can be respectively adjusted to the desired amount of throughput without having the necessity for different diameters for the borings in the nozzle strip and whereby greater problems in respect to cleaning of the nozzle strip are not to be expected.

### SUMMARY OF THE INVENTION

For achievement of this object, it is proposed for a device of the aforementioned type that there is arranged in the flow channel of the nozzle strip at least one unilaterally attached restricting strip projecting to one side whose free edge forms a flow-through slot with the side of the flow channel. This design allows, in a simple manner, an adjustment of the amount of substance flowing into the exit region of the nozzle strip in that the flow-through slot is kept rather wide, which is made possible through simple replacement of the restricting strip. Such a replacement is relatively simple because-of-the unilateral attachment-and cleaning is also made possible in a relatively simple manner. In addition, borings in the nozzle strip, which are adjustable in their diameter to the amount to be extruded, can be eliminated. The flow channel in the nozzle strip can be provided with a large cross section and serves as a kind of a calming path for feeding the masses to be extruded since the flow-through slot determining the through-flowing amount of substance lies only behind these flow channels. In addition, said flow channels do not tend to become clogged because of their larger cross section.

It has been shown to be of advantage if the flow-through slot lies on the side of the nozzle strip that forms the front edge of the nozzle strip, as viewed in the rotating direction of the drum. Through this design, it is achieved in a relatively simple manner that the entire discharge groove of the nozzle strip—which lies opposite the inner circumference of the rotatable drum—is filled with the substance to be extruded and sufficient time can be made available, depending on the width of said discharge groove, so that the substances to be extruded pass through the apertures of the rotatable drum and fall off in form of droplets.

In development of the invention, the restricting strip can be fastened by means of screws that run from the open side of the discharge groove through openings in the area of the restricting strip edge. This type of fastening is simple and makes rapid replacement possible. Two restricting strips can also be arranged in an advantageous manner one behind the other so that their flow-through slot lies on opposite sites. A sort of a labyrinth passage is created thereby through which the mass to be extruded must flow before reaching the apertures of the rotatable drum. This leads to calming of the flow, especially when higher throughputs are desired, which is necessary for flawless droplet shaping.

In development of the invention, the restricting strip can also be arranged at an angle to the inflow direction of the substance in such a manner that the free strip edge lies downstream from the attached edge. The restricting strip serves then also as flow guiding means, which can also lead to flow calming of the exiting substance. Especially in such a design there can be proposed in the development of the invention that the side of the restricting strip facing away from the discharge groove of the nozzle strip lies opposite to the projections on the groove bottom, whereby said projections form at least one or preferably a plurality of restricting slots together with the restricting strip lying behind one another in the flow direction. These restriction points lying one behind the other in the flow direction can also be employed as flow-calming means, depending on viscosity and nature of the substance to be extruded.

However, the invention makes also it also possible to extrude larger amounts of substances without letting flow conditions enter the turbulence range, such as through the increase of the Reynold's number, which could endanger flawless droplet shaping.

In development of the invention it is proposed that the ratio of the diameter of the aperture to the diameter of the drum is greater than 1:150 and that a transition piece with a connecting passage is provided between the nozzle strip and the feed tube extending axially inside the drum whereby said feed tube does not completely fill the interior of the drum, and whereby there is at least one restricting path provided in said connecting passage for additional calming and distribution of the through-flowing substance over its axial length. In development of the invention, said connecting passage can be designed as a passage extending through nearly the entire axial length of the drum whereby said passage narrows in form of a wedge in the flow direction. It has been shown that through such a design—in which a considerably larger diameter of the rotatable drum can be provided compared to heretofore known designs—considerably larger amounts of substances can be flawlessly released in the form of droplets since it is ensured that the flow conditions of the substances to be extruded can remain laminar so that there is no chance that the droplet-release process does not take place in the desired manner. There is also the advantage reached that an extraordinary stability and greater strength can be achieved because of the clearly larger diameter of the rotating drum, which can now be approximately 250 mm even when the material strength of the drum is not considerably increased compared to known designs. This greater strength allows for the realization of greater axial lengths and thus greater belt widths so that production can be increased as well through this measure. Because of the employed larger diameter of the rotatable drum, its speed can be a kept in a range in which the centrifugal forces can be controlled, in spite of the production increase, so that the novel device for producing granulates does not have the tendency to let any material possibly adhering to the drum be radially released in the form of a spray because of the lower circumferential velocity.

The use of larger drum diameters makes also sufficient space available for installation so that such a device is favorable for assembly even if the outer measurements are increased. The feed tube extending axially in the inner cavity of the drum must be provided with separate heating. There is still sufficient space inside the drum for such an arrangement, which can also run along the axially extending transition piece leading to the nozzle strip.

### BRIEF DESCRIPTION OF THE DRAWINGS

In the following, the invention is described and illustrated in the drawings with the aid of embodiment examples.

FIG. 1 shows the schematic cross section through a device identified as a so-called rotor drop shaper according to the invention;

FIG. 2 shows a partial view in the direction of arrow 11 onto the nozzle strip used in the device of FIG. 1;

FIG. 3 shows a section through the nozzle strip according to the section line 111-111 in FIG. 2;

FIG. 4 shows a top view onto the nozzle strip in the direction of arrow IV whereby the additional parts provided in FIG. 1 and FIG. 2 have been omitted;

FIG. 5 shows a longitudinal section through another embodiment of the invention wherein a considerably larger diameter for the rotating drum is provided compared to FIG. 1;

FIG. 6 shows the enlarged illustration of a cross section through the device according to FIG. 5 sectioned in the direction of line VI-VI;

FIG. 7 shows a-partial view of-the nozzle strip provided in the embodiment example of FIG. 6 as viewed in the direction of arrow IX; however, without the inserted restricting strip, without the transition piece receiving the nozzle strip, and without the rotating drum;

FIG. 8 shows a schematic illustration of the section through the embodiment of FIG. 5 in the direction of the section line XIII-XIII;

FIG. 9 shows the view onto the nozzle strip and the transition piece of the embodiment of FIG. 6 as seen in the direction of arrow IX whereby the rotating drum has been omitted and only a partial area is illustrated;

FIG. 10 shows a top view onto the transitional piece of the device of FIG. 6 in the viewing direction of arrow X;

FIG. 11 shows a cross section through a nozzle strip similar to the one of the illustration in FIG. 6, but being in another embodiment;

FIG. 12 shows the cross section of an additional embodiment of the nozzle strip;

FIG. 13 shows also a further embodiment of a nozzle strip that is similar to the one in FIG. 11 and FIG. 12.

### DETAILED DESCRIPTION OF PREFERRED EMBODIMENTS OF THE INVENTION

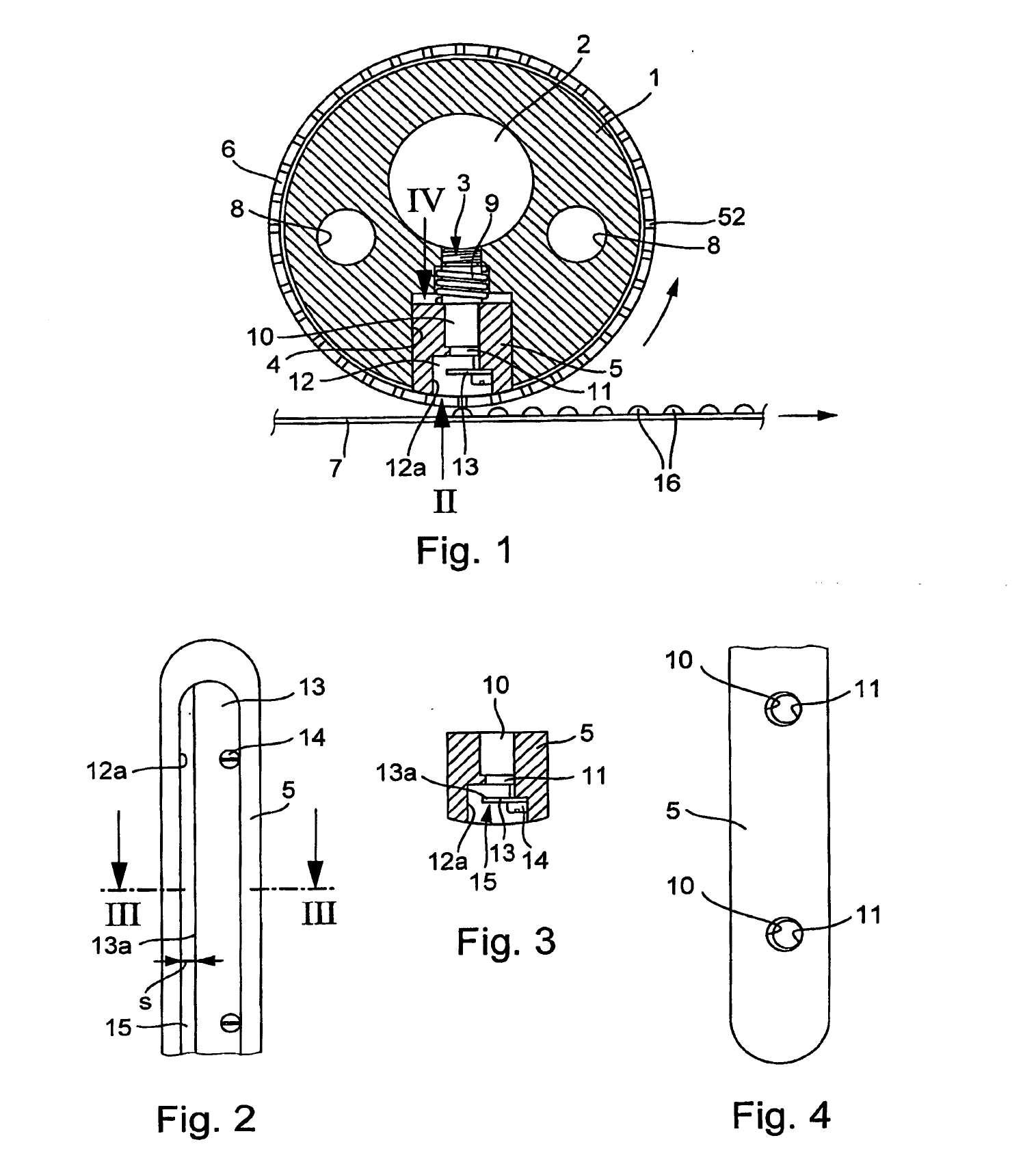

FIG. 1 shows that the rotor drop shaper illustrated in cross section consists of three parts: mainly, a fixed cylindrical inner body 1, which extends with an axially-running feed channel 2 for the substance to be granulated, and having a flow channel 3 radially branching-off from said feed channel 2 and a recess 4 adjacent to said flow channel 3 leading to the outer circumference of the inner body 1, as well as a nozzle strip 5 held radially slidable in said recess 4; a rotating drum 6 revolving around the cylindrical inner body 1; and a cooling and conveyor belt 7 moving under said drum. The inner body 1 is equipped with two heating ducts 8 running parallel to said feed channel and the nozzle strip 5 is pushed radially toward the outside by a pressure spring 9 in the recess 4 so that said nozzle strip 5 rests against the inner circumference of the rotating drum 6.

The nozzle strip 5 itself is illustrated again in FIG. 2 through FIG. 4 and it is shown that said-nozzle strip 5 is provided with connecting borings which transform into apertures 11 of a somewhat smaller diameter. The apertures 11 lead to a groove-shaped recess 12 that is open toward the rotating inner circumference of said drum. A restricting strip 13 is fastened to said recess by means of screws 14, which lead through the strip 13 in the area of a side edge and which are screwed down in the body of the nozzle strip 5. Said screws 14 are thereby accessible from the open side of the recess 12. The detached and free edge 13a of the restricting strip 13 forms a flow-through slot 15 of a width s together with the side 12a of recess 12. This flow-through slot 15 serves as a restricting point for the material to be extruded coming through the feed channel 2 and said slot 15 determines the developing shape of the droplets 15 together with the temperature-dependent viscosity of the substance to be granulated in addition to the pressure whereby said droplets 15 solidify on the belt 7 where they can be subsequently packaged in a manner known in the art.

As it can be clearly seen, the width s of the slot 15 can be determined through the width of the restricting strip 13. It can also be seen that this restricting strip 13 can be inserted into the nozzle strip 5 in a simple manner. Cleaning is also easily possible because of the good accessibility, if necessary.

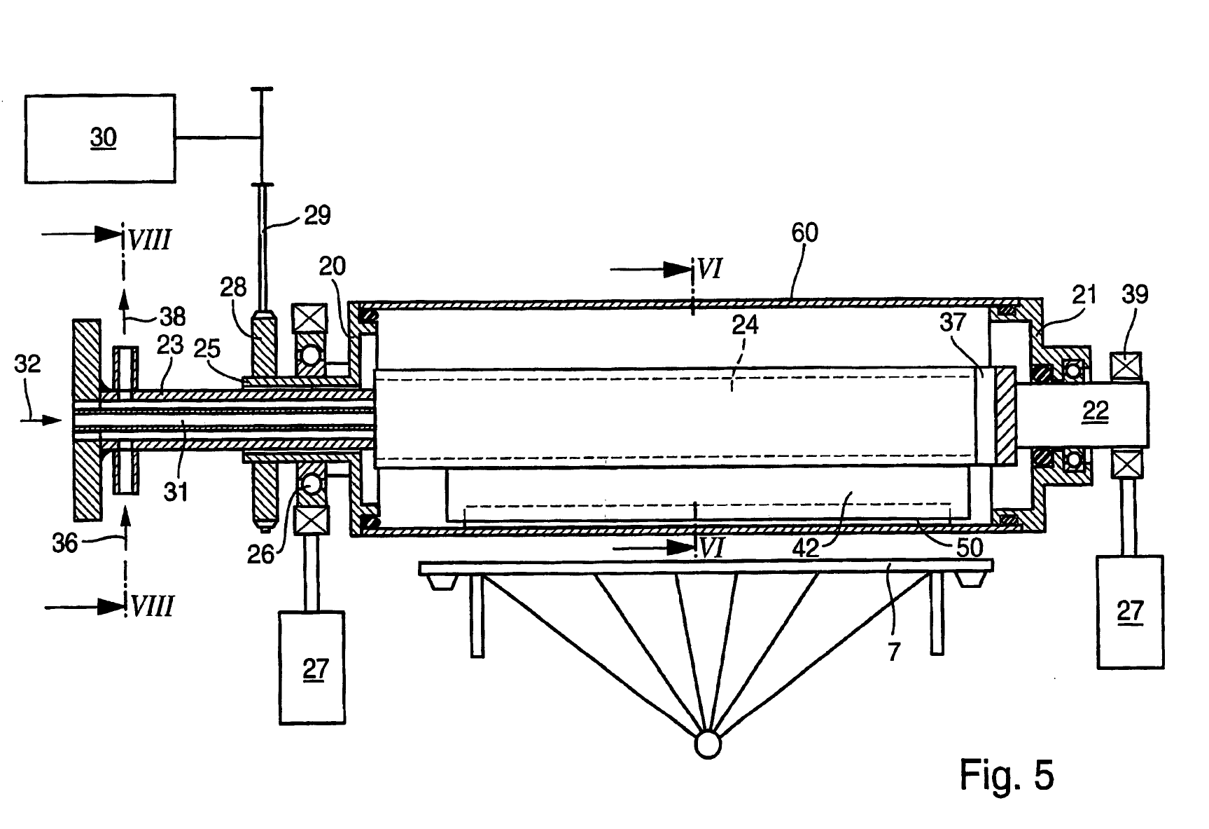

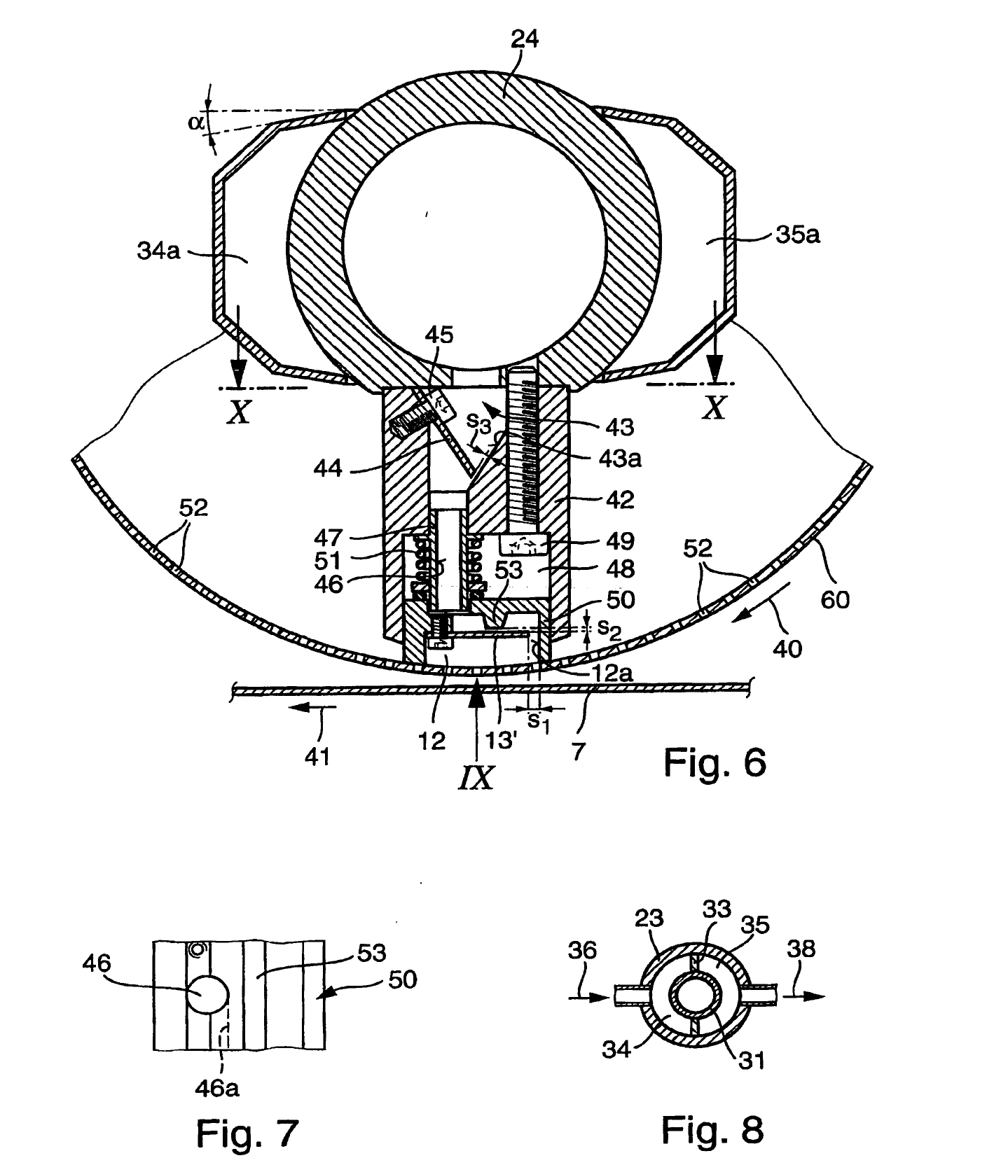

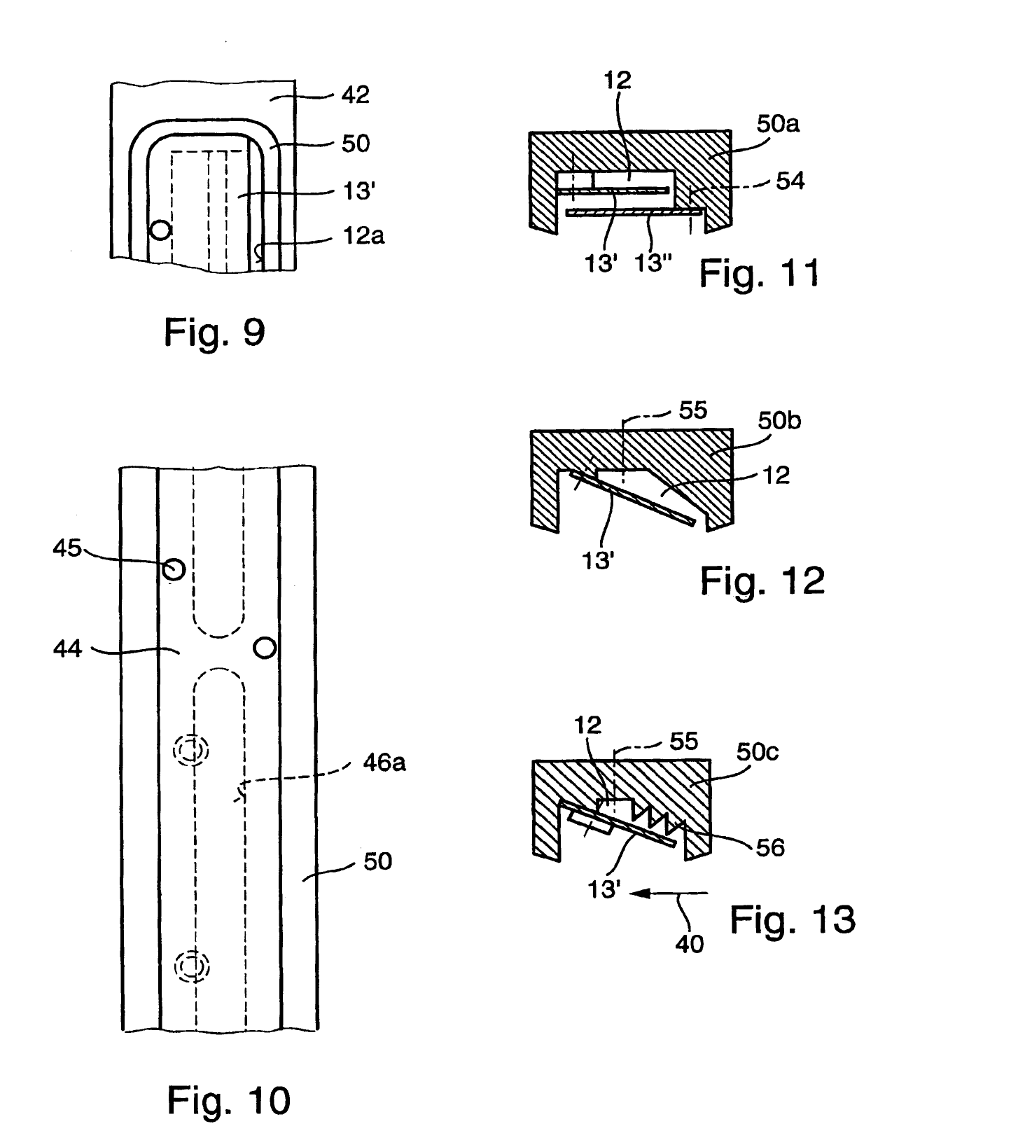

FIG. 5 and FIG. 6 show another embodiment of a so-called rotor drop shaper wherein the guide for the rotating drum 60 has been eliminated at the circumference of the inner body 1, as it is the case in FIG. 1. The perforated drum 60 is actually attached on flanges 20 and 21 in the area of its two ends whereby the flanges themselves are mounted with hub elements on shaft stubs 22 or 23, which project axially from a feed tube 24 that runs coaxial to the drum in the cavity of the drum 60 and at a distance to its inner circumference. The hub 25 connected to the flange 20 is thereby secured on a bearing 26 that is connected to fixed support elements 27. The hub 25 is also provided with a drive wheel 28 which can be rotated by a belt drive or a chain drive 29 and a drive motor 30, which is not further illustrated. The shaft stub 23 of the feed tube 24 is designed in the form of a pipe encompassing a coaxially extending inner tube 31 (see also FIG. 8), which serves as feed channel for the substance to be granulated and which leads into the tube-shaped feed channel 24. The substance to be granulated is fed from the outside in the direction of arrow 32. Heating of the tube 31 and the feed tube 24 is provided to prevent cooling of the substance or to heat the same whereby the heated areas are the inner spaces 34, 35 defined by the shaft stud 23 and the feed tube 31 and the partition 33 (FIG. 8) and by the cavities 34a and 35a surrounding the inner feed tube 24. A heating medium is moved in the direction of arrow 36 into the space 34, flows through the space 34 and space 34a up to the end 37 and it is subsequently returned to the entrance area where it leaves space 35 in the direction of arrow 38 through a corresponding discharge nozzle.

The shaft stub 22 of the feed tube 24 is also secured in a bearing 39 on a fixed support element 27 and serves as a bearing surface for the hub of the flange 21.

As it is shown in FIG. 6, the inside of the cavity of the drum 60 has a very large diameter so that there is a large space created inside the drum 60, which makes assembly of the device relatively simple, and whereby said drum is rotated in the direction of arrow 40 in such a manner that circumferential velocity is the same and is in the same direction as the movement of the belt 7 moving in the direction of arrow 41. The large drum diameter permits also to make the axial length of the drum relatively great without experiencing problems with material strength. This means also that an increase in production is made possible alone for this reason. However, production increase is also possible because of the selected larger diameter of the drum since there is the possibility now to increase the circumferential velocity and not let the centrifugal forces become too great because of an excess speed. Added thereto is also the fact that the region of the drum, which faces the belt 7 moving underneath and which is still close enough to the belt to effect the droplet-release process, is also larger because of the larger curvature in this region of the drum so that the width of the nozzle strip, as seen in the movement direction 41 of the belt 7, can also become considerably greater, which-can be clearly observed from-comparison of FIG. 1 and FIG. 6.

A transition piece 42 is provided to bridge the space between the feed tube 24 and the lower region of the drum 60 whereby said transition piece 42 has the shape of a strip with the approximate width of the belt 7. The transition piece 42 is provided with a downwardly narrowing, wedge-shaped inflow area 43 at the region facing the feed tube 24, as shown in FIG. 6 and FIG. 10, whereby a guide plate 44 protrudes into said inflow area 43 fastened only at one edge with screws 45 in a similar manner as the restricting strip 13′. A gap S₃ is created between the free edge of the guide plate 44 and the slanted side 43a of the wedge-shaped inflow area whereby said gap S₃ serves for apportioning the amount of substance to be extruded entering the neighboring area. The wedge-shaped inflow area 43, as it is shown in FIG. 7 and FIG. 10, transforms into an opening designed as a cylindrical boring 46 or as a elongated orifice 46a, which projects into the recess 48 of the transition piece 42 wherein a fastening screw 49 is disposed to fasten the transition piece 42 to the tube 24. The nozzle strip 50 is slidably arranged in the recess 48 having parallel sides whereby said nozzle strip 50 is pushed downwardly by means of a pressure spring 51 and it is pushed with its two legs defining the groove-like recess 12 against the inner circumference of the drum 60. The transition piece 47 is held in its position by said spring 51 at the same time.

The nozzle strip 50 is provided with a restricting strip 13′ at a distance to the bottom, just as the nozzle strip 5, whose free edge forms a gap with a width S₁ together with the side 12a. This gap can serve for apportioning of the mass extruded through the aperture 52 of the drum 60 in the same manner as already described with the aid of FIG. 1. The gap S₁ is here already arranged on the side of the nozzle strip 50, which is the first inner edge of the nozzle strip 50 as seen in the rotational direction 40 of the drum 60 or in the movement direction 41 of the belt 7.

As it is also shown in FIG. 6, it is also possible to additionally attach a strip-type projection 53 at the bottom of the groove-like recess 12, which forms thereby an additional gap with the width S₂ together with the restricting strip 13′. This gap serves to calm the through-flowing amount of substance that is partially blocked here inside the flow channel 46 and behind the guide plate 44. This measure leads to the fact that a viscous flow is generally maintained at a relatively large throughput of the substance to be processed, which ensures the desired droplet shaping in the region between the two sides of the nozzle strip 50.

FIG. 11 through FIG. 13 show other designs of the nozzle strip 50, which were therefore provided with the reference numbers 50a, 50b and 50c.

In case of FIG. 11, the nozzle strip 50a is mainly provided with a first restricting strip 13′, roughly in the same manner as it is the case in FIG. 6. Apertures 43 and the groove-like recesses 12 are not illustrated in detail in FIG. 11 through FIG. 13. In FIG. 11, however, the nozzle strip 50 is additionally provided with a second restricting strip 13′, which is also attached only unilaterally on a projection shoulder 54, in this case, in the region of one of the legs of the C-shaped nozzle strip 50a. The two restricting strips 13′ and 13″ form in this way a second passage gap with one of the sides of the recess 12 having a labyrinth-type passage in between for the substance to be released in droplets. Such a design serves to calm the flow, should it be necessary, depending on the viscosity of the substance to be processed.

FIG. 12 shows a nozzle strip 50b whereby the restricting strip 13′ is slanted at an angle to the inflow occurring in the direction of axis 55, particularly in such a manner that its free edge lies lower than (downstream of) the attached edge in the flow direction. The restricting strip 13′ serves therefore as a flow guide-plate. It also serves to slow-down the through-flowing amount of substance and it can also be employed in this design in a relationship to the flow characteristics and the flow-through amount of the substance to be processed.

This also applies to the nozzle strip 50c in FIG. 13 whereby the restricting strip 13′ is inserted at an angle to the flow direction in the same manner as in FIG. 12. However, a ceiling of the recess 12 of the nozzle strip 50c is here provided with a plurality of ribs 56, arranged one behind the other, and oriented toward the restricting strip 13′, respectively, whereby said ribs 56 form themselves a passage gap with the surface of the restricting strip 13′. This measure is also a measure which serves to calm the flow and which does not influence the droplet shaping in an undesired manner through a flow velocity that is too-high.

1-11. (canceled)

12. Apparatus for extruding a flowable substance comprising a rotating cylindrical drum provided with apertures extending around the drum circumference, a feed device for the flowable substance arranged inside the drum, and a nozzle strip arranged at a lower region of an inner circumference of the drum, the nozzle strip having a flow channel communicating with said feed device and through which the substance is fed substantially uniformly across an axial length of the drum to pass through the apertures and form droplets, wherein there is arranged in the flow channel at least one restricting strip having a free edge forming a flow-through slot with a side of the flow channel.

13. Apparatus according to claim 12, wherein the restricting strip includes a second edge situated opposite to the free edge and mounted to the nozzle strip, wherein the restricting strip extends from the second edge to the free edge in a direction generally opposite a direction of rotation of the drum.

14. Apparatus according to claim 13, wherein the restricting strip is fastened to the nozzle strip by means of screw, which are accessible from a downwardly open side of the flow channel, the flow channel comprising an elongated groove extending substantially parallel to an axis of rotation of the drum.

15. Apparatus according to claim 12 wherein the at least one restricting strip comprises two restricting strips disposed one above the other and extending in mutually opposite directions, wherein the flow-through slots of the respective restricting strips are disposed on opposite sides of the flow channel and communicate with one another by a passage defined between the two restricting strips.

16. Apparatus according to claim 12 wherein the restricting strip is inclined with respect to a flow direction of the substance, wherein the free edge of the restricting strip lies downstream of an opposite second edge of the restricting strip with reference to the flow direction.

17. Apparatus according to claim 13 wherein the restricting strip is disposed beneath a ceiling surface of the flow channel, the ceiling including a plurality of downward projections that form flow gaps with the restricting strip, the flow gaps spaced apart in a direction of substance flow.

18. Apparatus according to claim 12, further comprising a transaction piece extending from the feed device and including a connecting passage therein, the nozzle strip disposed at a lower end of the connecting passage, the connecting passage including a flow restriction disposed above the nozzle strip to calm and distribute the substance along a length thereof disposed parallel to an axis of the drum, the drum having a diameter of at least 90 mm.

19. Apparatus according to claim 18 wherein a length of the connecting passage extends substantially the entire axial length of the drum, a portion of the axial passage disposed above the nozzle strip having a cross section which narrows in a direction generally toward the nozzle strip.

20. Apparatus according to claim 18 wherein the transition piece includes a plurality of apertures spaced apart along the length of the connecting passage, for interconnecting the restriction with the nozzle strip.

21. Apparatus according to claim 18 wherein the drum has a wall thickness in the range of 1.5 mm to 5.0 mm.

22. Apparatus according to claim 21 wherein the wall thickness is 2.0 mm.

23. Apparatus according to claim 18 wherein the drum diameter is not greater than 1,500 mm.

24. Apparatus according to claim 23 wherein the drum diameter is in the range of 300-450 mm.
